(19) United States
(12) Patent Application Publication
(10) Pub. No.: US 2026/0236246 A1
(43) Pub. Date: Aug. 13, 2026

(54) UPDATING BASE LAYER OF CONTAINERS

(71) Applicant: International Business Machines Corporation, Armonk, NY (US)

(72) Inventors: Yu Zui You, Ningbo (CN); Xiao Ling Chen, Changping District (CN); Heng Wang, Changping District (CN); Ying Mo, San Jose, CA (US); Qi Li, Beijing (CN)

(21) Appl. No.: 19/052,428

(22) Filed: Feb. 13, 2025

(51) Int. Cl. G06F 8/65

(52) U.S. Cl. CPC G06F 8/65

(57) ABSTRACT

Updating a first base layer of at least one operational container includes detecting a trigger to update the first base layer of the at least one operational container. A system imports the at least one operational container in a replacement memory of at least one containerization system based on the detection of the trigger. The system imports a second base layer of the at least one operational container in the replacement memory based on the importation of the at least one operational container in the replacement memory. The system associates the second base layer with a container filesystem of the at least one operational container based on the importation of the second base layer in the replacement memory. The system updates the first base layer with the second base layer based on the association of the second base layer.

### BACKGROUND

The disclosure relates to containers and more particularly, to updating containers.

With the advancements in technology, container technology has become a fundamental component of modern cloud-native applications, playing a role in the development and deployment of software in distributed computing and microservices architectures. As organizations increasingly adopt cloud-native strategies, the container technology provides efficient solutions by packaging applications with their dependencies for rapid deployment, scalable solutions through easy replication and orchestration to meet varying loads of the organizations, and flexible solutions by enabling consistent operation across different environments facilitating quick adaptation to changing business requirements. By packaging the applications and their dependencies into isolated units, containers ensure consistency across different environments, thus addressing common deployment challenges and enhancing collaboration between development and operations teams.

Further, a key innovation within the container technology is a layered file system used in container images. The layered file system allows for the creation of the container images in layers, where each layer represents incremental changes or additions. Furthermore, the portability of the containers simplifies the migration of the applications between multiple cloud platforms and on-premises infrastructures, making the container technology a fundamental tool for the organizations to optimize their software deployment and management processes.

### SUMMARY

In various embodiments of the disclosure, a computer-implemented method for updating a base layer of containers is described. The computer-implemented method includes detecting a trigger to update a first base layer of at least one operational container. The computer-implemented method further includes importing the at least one operational container in a replacement memory of at least one containerization system based on the detection of the trigger. Further, the computer-implemented method includes importing a second base layer of the at least one operational container in the replacement memory based on the importation of the at least one operational container in the replacement memory. The computer-implemented method further includes associating the second base layer with a container filesystem of the at least one operational container based on the importation of the second base layer in the replacement memory. The computer-implemented method also includes updating the first base layer with the second base layer based on the association of the second base layer.

In various embodiments of the disclosure, a computer system for updating a base layer of containers is described. The computer system includes a processor set, one or more computer-readable storage media, and program instructions stored on one or more computer-readable storage media.

Additional technical features and benefits are realized through the techniques of the disclosure. Embodiments and aspects of the disclosure are described in detail herein and are considered a part of the claimed subject matter. For a better understanding, refer to the detailed description and the drawings.

### BRIEF DESCRIPTION OF THE DRAWINGS

The following description will provide details of preferred embodiments with reference to the following figures wherein:

FIG. 1 is a diagram that illustrates a computing environment for updating a base layer of containers, in accordance with an embodiment of the disclosure;

FIG. 2 is a diagram that illustrates a network environment for updating the base layer of the containers, in accordance with an embodiment of the disclosure;

FIG. 3 is a diagram that illustrates exemplary operations of a system for updating the base layer of the containers, in accordance with an embodiment of the disclosure;

FIG. 4 is a diagram that illustrates exemplary operations for updating the base layer of the containers, in accordance with an embodiment of the disclosure;

FIG. 5 is a diagram that illustrates exemplary operations for updating a state of the at least one operational container, in accordance with an embodiment of the disclosure;

FIG. 6 is a diagram that illustrates a flowchart for updating the base layer of the containers, in accordance with an embodiment of the disclosure;

FIG. 7 is a diagram that illustrates a first flowchart of an exemplary method for updating the base layer of the containers, in accordance with an embodiment of the disclosure; and

FIG. 8 is a diagram that illustrates a second flowchart of an exemplary method updating the base layer of the containers, in accordance with an embodiment of the disclosure.

### DETAILED DESCRIPTION

Container technology has emerged as a fundamental component of modern cloud-native applications, playing a role in distributed computing and microservices architecture. Organizations use a layered file system of container images to achieve rapid application startup, scaling, and migration of applications within containerized environments. However, a significant challenge arises when there is a need to update a base layer of a container. Traditional container systems restart the container to implement these updates, which can lead to brief service interruptions.

In enterprise-level applications (e.g., applications operating in production environments), regular updates to an operating system associated with the container, core libraries of the container, and components integral to the applications running within the container are performed to address vulnerabilities and enhance functionality. In the traditional container systems, the applications running in the container undergo scheduled updates to ensure the security and stability of the system running the container. Further, developers take multiple weeks in a process of identifying issues in the applications and deploying the scheduled updates to resolve the identified issues. The scheduled updates involve fixes and optimizations to the operating system and base libraries of the container, which can significantly impact the regular operations and security of the container.

To address the aforementioned challenges, the proposed system is configured to perform dynamic updates of the base layers of the container while the container is actively running. The proposed system is configured to perform seamless updates of the base layers by modifying the metadata of the base layers without interrupting the running container. The proposed system not only seamlessly updates the base layers but also ensures that the enterprise-level applications can maintain availability and security, ultimately leading to improved operational performance.

In various embodiments of the disclosure, a computer-implemented method for updating the base layer of containers is described. The computer-implemented method includes detecting a trigger to update a first base layer of at least one operational container. The computer-implemented method further includes importing the at least one operational container in a replacement memory of at least one containerization system based on the detection of the trigger. Further, the computer-implemented method includes importing a second base layer of the at least one operational container in the replacement memory based on the importation of the at least one operational container in the replacement memory. The computer-implemented method further includes associating the second base layer with a container filesystem of the at least one operational container based on the importation of the second base layer in the replacement memory. The computer-implemented method also includes updating the first base layer with the second base layer based on the association of the second base layer.

The computer-implemented method for updating the first base layer of the at least one operational container offers significant advantages in terms of memory, processor, and overall hardware efficiency. By leveraging the replacement memory, the computer-implemented method minimizes the need for direct modifications to the at least one operational container, reducing the risk of memory fragmentation and ensuring memory utilization. The use of a temporary workspace (e.g., the replacement memory) allows the system to isolate the update process, preventing memory overhead in a primary runtime environment. This isolation ensures that only the needed layers are loaded into memory, avoiding redundant data duplication and conserving memory resources. Further, the computer-implemented method performs dynamic updating of container layers without requiring a complete restart of the at least one operational container. This efficiency means that the Central Processing Unit (CPU) can continue executing tasks without interruption, leading to better utilization of processing power and reducing idle time. By importing the at least one operational container and the second base layer into the replacement memory, the system minimizes the time the CPU spends waiting for updates to be completed. This reduction in latency enhances the responsiveness of applications running within the containers, providing a smoother user experience. The computer-implemented method can leverage multi-core CPU architectures effectively. Since the update process can occur in parallel with other operations, multiple cores can handle different tasks simultaneously, improving the overall throughput and performance of the system. This is particularly beneficial in environments where multiple containers are being managed concurrently.

In various embodiments of the disclosure, the computer-implemented method further includes configuring the replacement memory in the at least one containerization system based on the detection of the trigger. Configuring the replacement memory in the at least one containerization system based on the detection of the trigger optimizes resource allocation and enhances system performance. This approach allows for the dynamic adjustment of memory resources, ensuring that only the needed components are loaded into memory during the update process. As a result, it minimizes memory overhead and reduces the likelihood of contention among processes, leading to more efficient memory usage. By isolating the update process in a dedicated replacement memory, the system can achieve lower latency and faster access times as compared to traditional systems, ultimately improving the overall responsiveness of a container orchestration environment.

In various embodiments of the disclosure, the computer-implemented method includes removing at least one first link between the first base layer and a set of parent layers associated with the first base layer. The at least one first link is removed based on the association of the second base layer. Further, the computer-implemented method includes establishing at least one second link based on the removal of the at least one first link. The at least one second link is between the second base layer and the set of parent layers. By removing outdated links, the computer-implemented method streamlines an architecture of the at least one operational container, reducing the complexity of the layer relationships. This simplification minimizes the memory footprint, as fewer links mean less metadata to manage and store, leading to more efficient memory utilization. The reduction in complexity also enhances the speed of operations, as the computer-implemented method can quickly navigate the updated layer structure without the overhead of managing redundant connections. Further, by ensuring that the links reflect the most current state of the at least one operational container, the computer-implemented method can operate with reliability and stability, minimizing the risk of errors that may arise from outdated associations.

In various embodiments of the disclosure, the computer-implemented method includes updating first metadata of the first base layer with second metadata of the second base layer. The first metadata of the first base layer is updated based on the update of the first base layer. By maintaining up-to-date metadata, the computer-implemented method can optimize memory access patterns, allowing the processor to quickly locate and utilize the relevant data associated with the base layers. This leads to improved cache performance, as the likelihood of cache hits increases when the metadata is current and accurately represents the data structure. Further, this reduces latency and enhances the overall speed of operations. Furthermore, updating metadata helps in minimizing the risk of errors during data operations. When the metadata is synchronized with the actual state of the base layers, the computer-implemented method can avoid potential conflicts or inconsistencies that could arise from outdated information. The management of metadata reduces the processing overhead on the CPU. By streamlining the metadata update process, the system can allocate more processing power to tasks, enhancing overall system throughput.

In various embodiments of the disclosure, the computer-implemented method includes removing the first base layer from the container filesystem based on the update of the first metadata. By eliminating outdated layers, the computer-implemented method reduces the overall complexity of the container filesystem. This simplification leads to a smaller memory footprint, as fewer layers mean less data to manage and store. Further, this can improve memory utilization, allowing the hardware to allocate resources more effectively and reducing the likelihood of memory fragmentation. Furthermore, the removal of the first base layer streamlines data access paths. With fewer layers to traverse, the computer-implemented method can achieve faster data retrieval times, which enhances the performance of containerized applications. By updating the file system to reflect the current state of the application, the computer-implemented method minimizes the risk of errors that could arise from outdated or inconsistent data. This reliability is used for maintaining the stability of the container environment, ensuring that the hardware operates smoothly without interruptions.

In various embodiments of the disclosure, the computer-implemented method includes detecting one or more issues associated with the update of the first base layer with the second base layer. Further, the computer-implemented method includes generating an error report based on the detection of the one or more issues. Furthermore, the computer-implemented method includes outputting the error report on a user device. Early detection of the one or more issues allows the computer-implemented method to proactively address potential problems before they escalate into more significant failures. This functionality minimizes downtime and ensures that the hardware operates smoothly, as it can quickly revert to a stable state or implement corrective measures without extensive manual intervention. Further, generating an error report provides valuable insights into the nature of the issues encountered during the update process. This information can be used to optimize future updates and refine the overall system architecture, leading to improved resource allocation and more efficient use of hardware. By understanding the root causes of errors, developers can make informed decisions that enhance the robustness of the container orchestration environment.

In various embodiments of the disclosure, the error report includes a summary of the update of the first base layer with the second base layer, the one or more issues, a set of error codes associated with the one or more issues, and one or more actionable insights for resolving the one or more issues. Having a detailed summary of the update process allows system administrators to quickly understand the context of the one or more issues. This functionality achieves faster diagnosis and resolution, reducing the time the system may be in a degraded state. By minimizing downtime, the hardware can maintain availability and performance levels, which are used in environments that require continuous operation. Further, the inclusion of specific error codes associated with the one or more issues provides a standardized way to identify and categorize problems. This standardization performs quicker troubleshooting, as administrators can reference known issues and their solutions without needing to investigate each problem from scratch. This efficiency not only saves time but also optimizes the use of hardware resources by allowing the system to recover more swiftly. Furthermore, the provision of actionable insights for resolving the one or more issues empowers users to take immediate corrective actions. This proactive approach reduces reliance on extensive support processes and allows for quicker remediation of problems, which can lead to improved system stability and performance.

In various embodiments of the disclosure, the computer-implemented method includes obtaining container information of the at least one operational container. Further, the computer-implemented method includes updating a state of the at least one operational container based on the container information and the one or more issues. Real-time awareness of container states allows for more effective monitoring and management of operational containers. By continuously updating the state based on current information, the system can ensure that it accurately reflects the operational status of each container. This leads to improved decision-making, as administrators can quickly identify which containers are functioning and may require attention or intervention. Further, the ability to update the state based on detected issues enhances system resilience. When issues are identified and addressed promptly, the likelihood of cascading failures or performance degradation is significantly reduced. This proactive approach helps maintain the overall health of the container environment, ensuring that hardware resources are utilized efficiently and effectively.

In various embodiments of the disclosure, the container information of the at least one operational container includes at least one of a process identifier of the at least one operational container, a name of the at least one operational container, a user identifier associated with a user of the at least one operational container, a file associated with the at least one operational container, network connection information of the at least one operational container, a memory usage information of the at least one operational container, thread information associated with the at least one operational container, a network namespace associated with the at least one operational container, a process tree associated with the at least one operational container, a file descriptor of the at least one operational container, a control group of the at least one operational container, a run time information of the at least one operational container, or security context information of the at least one operational container.

Having access to detailed operational metrics of the container information allows for enhanced monitoring and diagnostics of the container environment. By tracking attributes like memory usage and process identifiers, the system administrators can identify performance bottlenecks and resource contention issues more effectively. This capability performs proactive management, ensuring that hardware resources are allocated efficiently and that the system operates at defined performance levels. Further, the availability of user identifiers and security context information enhances security management within the container ecosystem. By associating containers with specific users and their permissions, the system can enforce security policies more effectively, ensuring that only authorized users can access or modify container resources. This adherence to security best practices helps protect sensitive data and maintain the integrity of the operational environment. Furthermore, the inclusion of network connection information and thread information allows for better network management and troubleshooting. Understanding how containers interact over the network and how threads are utilized can help identify issues related to connectivity or performance. This insight is used for maintaining a responsive and reliable application environment, particularly in distributed systems where network performance can significantly impact overall application behavior.

In various embodiments of the disclosure, the replacement memory corresponds to a logical memory within the at least one containerization system. Utilizing logical memory allows for greater flexibility in managing resources. The logical memory abstracts the physical memory, enabling the system to allocate and manage memory resources more efficiently. This abstraction can lead to improved performance, as the at least one containerization system can dynamically adjust memory allocation based on the current needs of the containers, optimizing resource usage and minimizing waste.

In various embodiments of the disclosure, a computer system for updating a base layer of containers is described. The computer system includes a processor set, one or more computer-readable storage media, and program instructions stored on one or more computer-readable storage media. The program instructions executable by the processor set to cause the processor set to detect a trigger to update a first base layer of at least one operational container. Further, the program instructions are executable by the processor set to cause the processor set to configure a replacement memory in at least one containerization system based on the detection of the trigger. The program instructions are executable by the processor set to cause the processor set to import the at least one operational container in a replacement memory based on the configuration of the replacement memory. Further, the program instructions executable by the processor set to cause the processor set to import a second base layer of the at least one operational container in the replacement memory based on the importation of the at least one operational container in the replacement memory. The program instructions executable by the processor set to cause the processor set to associate the second base layer with a container filesystem of the at least one operational container based on the importation of the second base layer in the replacement memory. Furthermore, the program instructions executable by the processor set to cause the processor set to update the first base layer with the second base layer based on the association of the second base layer.

The computer system for updating the first base layer of the at least one operational container offers significant advantages in terms of memory, processor, and overall hardware efficiency. By leveraging the replacement memory, the computer system minimizes the need for direct modifications to the at least one operational container, reducing the risk of memory fragmentation and ensuring memory utilization. The use of a temporary workspace (e.g., the replacement memory) allows the system to isolate the update process, preventing memory overhead in a primary runtime environment. This isolation ensures that only the needed layers are loaded into memory, avoiding redundant data duplication and conserving memory resources. Further, the computer system performs dynamic updating of container layers without requiring a complete restart of the at least one operational container. This efficiency means that the Central Processing Unit (CPU) can continue executing tasks without interruption, leading to better utilization of processing power and reducing idle time. By importing the at least one operational container and the second base layer into the replacement memory, the system minimizes the time the CPU spends waiting for updates to be completed. This reduction in latency enhances the responsiveness of applications running within the containers, providing a smoother user experience. The computer system can leverage multi-core CPU architectures effectively. Since the update process can occur in parallel with other operations, multiple cores can handle different tasks simultaneously, improving the overall throughput and performance of the system. This is particularly beneficial in environments where multiple containers are being managed concurrently.

In various embodiments of the disclosure, the program instructions executable by the processor set to cause the processor set to remove at least one first link between the first base layer and a set of parent layers associated with the first base layer. The at least one first link is removed based on the association of the second base layer. Further, the program instructions executable by the processor set to cause the processor set to establish at least one second link based on the removal of the at least one first link. The at least one second link is between the second base layer and the set of parent layers. By removing outdated links, the computer system streamlines an architecture of the at least one operational container, reducing the complexity of the layer relationships. This simplification minimizes the memory footprint, as fewer links mean less metadata to manage and store, leading to more efficient memory utilization. The reduction in complexity also enhances the speed of operations, as the computer system can quickly navigate the updated layer structure without the overhead of managing redundant connections. Further, by ensuring that the links reflect the most current state of the at least one operational container, the computer system can operate with reliability and stability, minimizing the risk of errors that may arise from outdated associations.

In various embodiments of the disclosure, the program instructions executable by the processor set to cause the processor set to update first metadata of the first base layer with second metadata of the second base layer. The first metadata of the first base layer is updated based on the update of the first base layer. By maintaining up-to-date metadata, the computer system can optimize memory access patterns, allowing the processor to quickly locate and utilize the relevant data associated with the base layers. This leads to improved cache performance, as the likelihood of cache hits increases when the metadata is current and accurately represents the data structure. Further, this reduces latency and enhances the overall speed of operations. Furthermore, updating metadata helps in minimizing the risk of errors during data operations. When the metadata is synchronized with the actual state of the base layers, the computer system can avoid potential conflicts or inconsistencies that could arise from outdated information. The management of metadata reduces the processing overhead on the CPU. By streamlining the metadata update process, the computer system can allocate more processing power to tasks, enhancing overall system throughput.

In various embodiments of the disclosure, the program instructions executable by the processor set to cause the processor set to remove the first base layer from the container filesystem based on the update of the first metadata. By eliminating outdated layers, the system memory footprint, as fewer layers mean less data to manage and store. Further, this can improve memory utilization, allowing the hardware to allocate resources more effectively and reducing the likelihood of memory fragmentation. Furthermore, the removal of the first base layer streamlines data access paths. With fewer layers to traverse, the computer system can achieve faster data retrieval times, which enhances the performance of containerized applications. By updating the file system to reflect the current state of the application, the computer system minimizes the risk of errors that could arise from outdated or inconsistent data. This reliability is used for maintaining the stability of the container environment, ensuring that the hardware operates smoothly without interruptions.

In various embodiments of the disclosure, the program instructions executable by the processor set to cause the processor set to detect one or more issues associated with the update of the first base layer with the second base layer. Further, the program instructions executable by the processor set to cause the processor set to generate an error report based on the detection of the one or more issues. Furthermore, the program instructions executable by the processor set to cause the processor set to output the error report on a user device. Early detection of the one or more issues allows the computer system to proactively address potential problems before they escalate into more significant failures. This capability minimizes downtime and ensures that the hardware operates smoothly, as it can quickly revert to a stable state or implement corrective measures without extensive manual intervention. Further, generating an error report provides valuable insights into the nature of the issues encountered during the update process. This information can be used to optimize future updates and refine the overall system architecture, leading to improved resource allocation and more efficient use of hardware. By understanding the root causes of errors, developers can make informed decisions that enhance the robustness of the container orchestration environment.

In various embodiments of the disclosure, the error report includes a summary of the update of the first base layer with the second base layer, the one or more issues, a set of error codes associated with the one or more issues, and one or more actionable insights to resolve the one or more issues. Having a detailed summary of the update process allows system administrators to quickly understand the context of the one or more issues. This functionality performs faster diagnosis and resolution, reducing the time the system may be in a degraded state. By minimizing downtime, the hardware can maintain availability and performance levels, which are used in environments that require continuous operation. Further, the inclusion of specific error codes associated with the one or more issues provides a standardized way to identify and categorize problems. This standardization performs quicker troubleshooting, as administrators can reference known issues and their solutions without needing to investigate each problem from scratch. This efficiency not only saves time but also optimizes the use of hardware resources by allowing the system to recover more swiftly.

In various embodiments of the disclosure, the program instructions executable by the processor set to cause the processor set to obtain container information of the at least one operational container. Further, the program instructions executable by the processor set to cause the processor set to update a state of the at least one operational container based on the container information and the one or more issues. Real-time awareness of container states allows for more effective monitoring and management of operational containers. By continuously updating the state based on current information, the computer system can ensure that it accurately reflects the operational status of each container. This leads to improved decision-making, as administrators can quickly identify which containers may require attention or intervention. Further, the ability to update the state based on detected issues enhances system resilience. When issues are identified and addressed promptly, the likelihood of cascading failures or performance degradation is significantly reduced. This proactive approach helps maintain the overall health of the container environment, ensuring that hardware resources are utilized efficiently and effectively.

In various embodiments of the disclosure, the container information of the at least one operational container includes at least one of a process identifier of the at least one operational container, a name of the at least one operational container, a user identifier associated with a user of the at least one operational container, a file associated with the at least one operational container, network connection information of the at least one operational container, a memory usage information of the at least one operational container, thread information associated with the at least one operational container, a network namespace associated with the at least one operational container, a process tree associated with the at least one operational container, a file descriptor of the at least one operational container, a control group of the at least one operational container, a run time information of the at least one operational container, or security context information of the at least one operational container.

Having access to detailed operational metrics of the container information allows for enhanced monitoring and diagnostics of the container environment. By tracking attributes like memory usage and process identifiers, the system administrators can identify performance bottlenecks and resource contention issues more effectively. This capability performs proactive management, ensuring that hardware resources are allocated efficiently and that the system operates at defined performance levels. Further, the availability of user identifiers and security context information enhances security management within the container ecosystem. By associating containers with specific users and their permissions, the computer system can enforce security policies more effectively, ensuring that only authorized users can access or modify container resources. This adherence to security best practices helps protect sensitive data and maintain the integrity of the operational environment. Furthermore, the inclusion of network connection information and thread information allows for better network management and troubleshooting. Understanding how containers interact over the network and how threads are utilized can help identify issues related to connectivity or performance. This insight is used for maintaining a responsive and reliable application environment, particularly in distributed systems where network performance can significantly impact overall application behavior.

In various embodiments of the disclosure, the replacement memory corresponds to a logical memory within the at least one containerization system. Utilizing logical memory allows for greater flexibility in managing resources. The logical memory abstracts the physical memory, enabling the system to allocate and manage memory resources more efficiently. This abstraction can lead to improved performance, as the at least one containerization system can dynamically adjust memory allocation based on the current needs of the containers, optimizing resource usage and minimizing waste.

In various embodiments of the disclosure, a computer program product for updating a first base layer of at least one operational container is described. The computer program product includes one or more computer-readable storage medium and program instructions stored on the one or more computer-readable storage media to perform operations. The operations include detecting a trigger to update the first base layer of the at least one operational container. The operations include importing the at least one operational container in a replacement memory of at least one containerization system based on the detection of the trigger. Further, the operations include importing a second base layer of the at least one operational container in the replacement memory based on the importation of the at least one operational container in the replacement memory. The operations include associating the second base layer with a container filesystem of the at least one operational container based on the importation of the second base layer in the replacement memory. The operations also include updating the first base layer with the second base layer based on the association of the second base layer.

The computer program product for updating the first base layer of the at least one operational container offers significant advantages in terms of memory, processor, and overall hardware efficiency. By leveraging the replacement memory, the computer program product minimizes the need for direct modifications to the at least one operational container, reducing the risk of memory fragmentation and ensuring memory utilization. The use of a temporary workspace (e.g., the replacement memory) allows the system to isolate the update process, preventing memory overhead in a primary runtime environment. This isolation ensures that only the needed layers are loaded into memory, avoiding redundant data duplication and conserving memory resources. Further, the computer program product performs dynamic updating of container layers without requiring a complete restart of the at least one operational container. This efficiency means that the Central Processing Unit (CPU) can continue executing tasks without interruption, leading to better utilization of processing power and reducing idle time. By importing the at least one operational container and the second base layer into the replacement memory, the system minimizes the time the CPU spends waiting for updates to be completed. This reduction in latency enhances the responsiveness of applications running within the containers, providing a smoother user experience. The computer program product can leverage multi-core CPU architectures effectively. Since the update process can occur in parallel with other operations, multiple cores can handle different tasks simultaneously, improving the overall throughput and performance of the system. This is particularly beneficial in environments where multiple containers are being managed concurrently.

Various aspects of the disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated operation, concurrently, or in a manner at least partially overlapping in time.

A computer program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium is an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the disclosure, is not to be construed as storage in the form of transitory signals per se, such as radio waves or freely propagating electromagnetic waves, electromagnetic waves propagating through a waveguide, light pulses passing through a fiber optic cable, electrical signals communicated through a wire, and/or additional transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

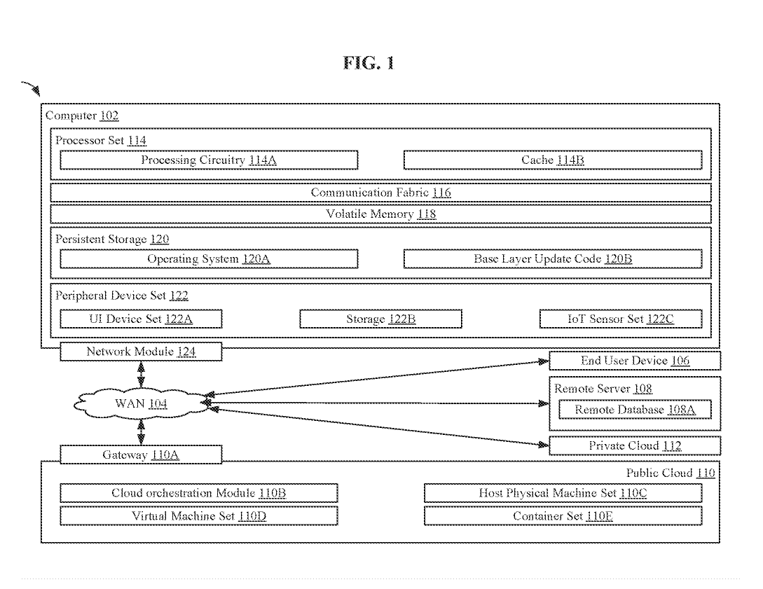

FIG. 1 is a diagram that illustrates a computing environment for updating a base layer of containers, in accordance with an embodiment of the disclosure. With reference to FIG. 1, there is shown a computing environment 100 that contains an example of an environment for the execution of at least some of the computer code involved in performing the disclosed methods, such as a base layer update code 120B. In addition to the base layer update code 120B, the computing environment 100 includes, for example, a computer 102, a wide area network (WAN) 104, an end user device (EUD) 106, a remote server 108, a public cloud 110, and a private cloud 112. In various embodiments of the disclosure, the computer 102 includes a processor set 114 (including a processing circuitry 114A and a cache 114B), a communication fabric 116, a volatile memory 118, a persistent storage 120 (including an operating system 120A and the base layer update code 120B (as identified above)), a peripheral device set 122 (including a user interface (UI) device set 122A, a storage 122B, and an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch or wearable computer, a mainframe computer, a quantum computer, or any form of a computer or a mobile device now known or to be developed in the future that is configured to run a program, accessing a network or querying a database, such as the remote database 108A. As is well understood in the art of computer technology, and depending upon the technology, the performance of a computer-implemented method may be distributed among multiple computers and/or between multiple locations. In this presentation of the computing environment 100, detailed discussion is focused on a single computer, specifically the computer 102, to keep the presentation as simple as possible. The computer 102 may be located in a cloud, even though it is not shown in a cloud in FIG. 1. The computer 102 is not required to be in a cloud except to any extent as may be affirmatively indicated.

The processor set 114 includes one, or more, computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B may be memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, the cache 114B for the processor set 114 may be located “off-chip.” In some computing environments, the processor set 114 may be designed for working with qubits and performing quantum computing.

Computer readable program instructions are typically loaded onto the computer 102 to cause a series of operations to be performed by the processor set 114 of the computer 102 and thereby affect a computer-implemented method, such that the instructions thus executed will instantiate the methods specified in flowcharts and/or narrative descriptions of computer-implemented methods included in this document (collectively referred to as “the disclosed methods”). These computer-readable program instructions are stored in various types of computer-readable storage media, such as the cache 114B and the storage media discussed below. The program instructions, and associated data, are accessed by the processor set 114 to control and direct the performance of the disclosed methods. In the computing environment 100, at least some of the instructions for performing the disclosed methods may be stored in the dynamic modification of the base layer update code 120B in the persistent storage 120.

The communication fabric 116 is the signal conduction path that allows the various components of the computer 102 to communicate with each other. Typically, this fabric is made of switches and electrically conductive paths, such as the switches and electrically conductive paths that make up buses, bridges, physical input/output ports, and the like. Further, signal communication paths may be used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 is characterized by a random access, but this is not required unless affirmatively indicated. In the computer 102, the volatile memory 118 is located in a single package and is internal to the computer 102, but alternatively or additionally, the volatile memory 118 may be distributed over multiple packages and/or located externally with respect to the computer 102.

The persistent storage 120 is any form of non-volatile storage for computers that is now known or to be developed in the future. The non-volatility of this storage means that the stored data is maintained regardless of whether power is being supplied to the computer 102 and/or directly to the persistent storage 120. The persistent storage 120 may be a read-only memory (ROM), but typically at least a portion of the persistent storage 120 allows the writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The code included in the base layer update code 120B typically includes at least some of the computer code involved in performing the disclosed methods.

The peripheral device set 122 includes the set of peripheral devices of the computer 102. Data communication connections between the peripheral devices and the components of the computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A may include components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B may be persistent and/or volatile. In various embodiments of the disclosure, the storage 122B may take the form of a quantum computing storage device for storing data in the form of qubits. In various embodiments of the disclosure where the computer 102 is required to have a large amount of storage (for example, where the computer 102 locally stores and manages a large database) then this storage may be provided by peripheral storage devices designed for storing very large amounts of data, such as a storage area network (SAN) that is shared by multiple, geographically distributed computers. The IoT sensor set 122C is made up of sensors that may be used in Internet of Things applications. For example, sensors may be a thermometer and a motion detector.

The network module 124 is the collection of computer software, hardware, and firmware that allows the computer 102 to communicate with computers through the WAN 104. The network module 124 may include hardware, such as modems or Wi-Fi signal transceivers, software for packetizing and/or de-packetizing data for communication network transmission, and/or web browser software for communicating data over the internet. In various embodiments of the disclosure, network control functions, and network forwarding functions of the network module 124 are performed on the same physical hardware device. In various embodiments of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the disclosed methods may typically be downloaded to the computer 102 from an external computer or external storage device through a network adapter card or network interface included in the network module 124.

The WAN 104 is any wide area network (for example, the internet) configured to communicate computer data over non-local distances by any technology for communicating computer data, now known or to be developed in the future. In various embodiments of the disclosure, the WAN 104 may be replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any computer system that is used and controlled by an end user (for example, a customer of an enterprise that operates the computer 102) and may take any of the forms discussed above in connection with the computer 102. The EUD 106 typically receives helpful and useful data from the operations of the computer 102. For example, in a hypothetical case where the computer 102 is designed to provide a recommendation to an end user, this recommendation may typically be communicated from the network module 124 of the computer 102 through the WAN 104 to the EUD 106. In this way, the EUD 106 may display, or present recommendations to an end user. In various embodiments of the disclosure, the EUD 106 may be a client device, such as a thin client, a heavy client, a mainframe computer, a desktop computer, and so on.

The remote server 108 is any computer system that serves at least some data and/or functionality to the computer 102. The remote server 108 may be controlled and used by the same entity that operates the computer 102. The remote server 108 represents the machines that collect and store helpful and useful data for use by computers, such as the computer 102. For example, in a hypothetical case where the computer 102 is designed and programmed to provide a recommendation based on historical data, then this historical data may be provided to the computer 102 from the remote database 108A of the remote server 108.

The public cloud 110 is any computer system available for use by multiple entities that provides on-demand availability of computer system resources and/or computer capabilities, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. The virtual computing environments (VCEs) typically take the form of virtual machines from the virtual machine set 110D and/or containers from the container set 110E. It is understood that these VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows the public cloud 110 to communicate through the WAN 104.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system may utilize resources of that computer, such as connected devices, files and folders, network shares, CPU power, and quantifiable hardware capabilities. However, programs running inside a container may only use the contents of the container and devices assigned to the container, a feature which is known as containerization.

The private cloud 112 may be similar to the public cloud 110, except that the computing resources are only available for use by a single enterprise. While the private cloud 112 is depicted as being in communication with the WAN 104, in various embodiments of the disclosure, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment of the disclosure, the public cloud 110 and the private cloud 112 are both part of a larger hybrid cloud.

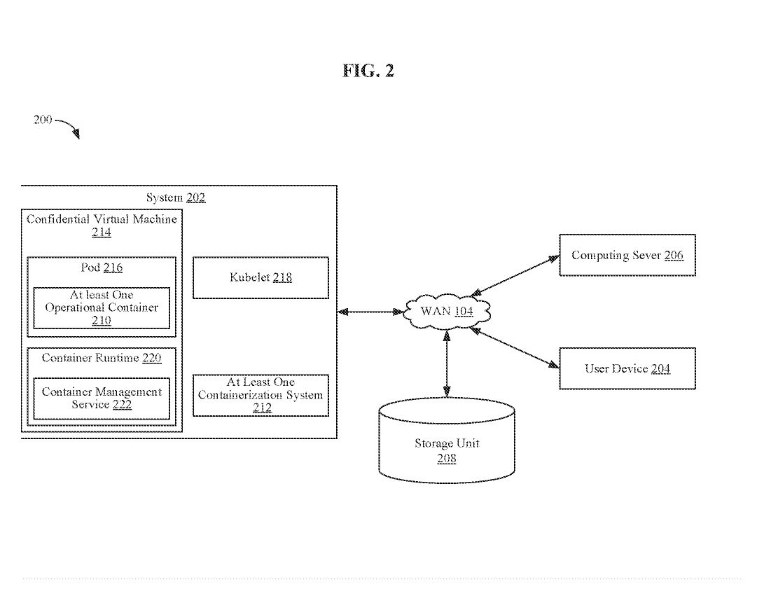

FIG. 2 is a diagram that illustrates a network environment for updating the base layer of the containers, in accordance with an embodiment of the disclosure. FIG. 2 is explained in conjunction with elements from FIG. 1. With reference to FIG. 2, there is shown a diagram of a network environment 200. The network environment 200 includes a system 202, a user device 204, and a computing server 206. Further, the network environment 200 also includes a storage unit 208, such as an internal storage unit and an external storage unit. The network environment 200 further includes a WAN 104 of FIG. 1. In an embodiment of the disclosure, the system 202 is an exemplary embodiment of the computer 102 in FIG. 1.

The system 202 may include suitable logic, circuitry, interfaces, and/or code that is configured for updating the base layer of the containers. In an embodiment of the disclosure, the base layer corresponds to a foundational layer that provides a core operating system, system tools, and dependencies for running an application. The base layer serves as the starting point for building a container image. In an embodiment of the disclosure, the container image corresponds to packaged executable files including a set of components to run the application. For example, the set of components may include an application code, a set of libraries, and a set of dependencies associated with the application. Further, the container is a standard unit of software that encapsulates the application and its dependencies, allowing the application to run consistently across different computing environments.

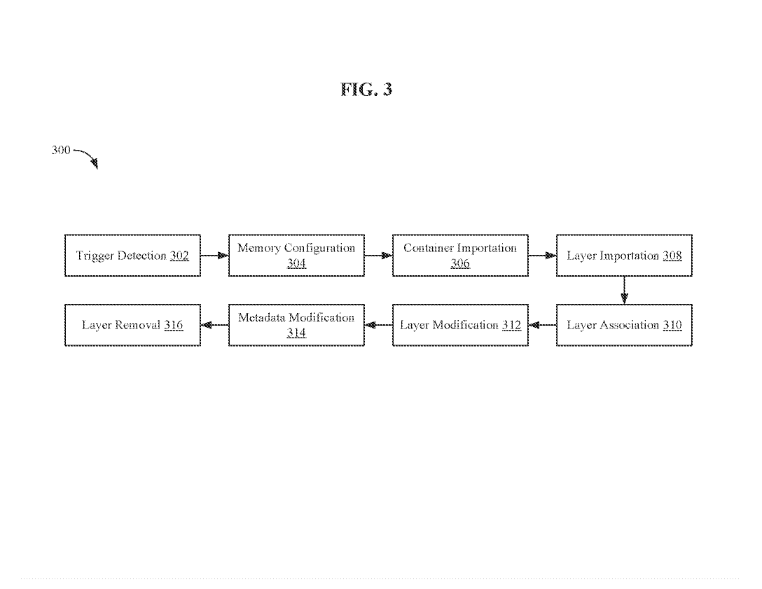

The system 202 may include suitable logic, circuitry, interfaces, and/or code that is configured for updating the base layer of the containers. The system 202 is configured to detect a trigger to update a first base layer of at least one operational container 210. In an embodiment of the disclosure, the first base layer is an original or currently deployed version of a base layer that the at least one operational container 210 is using. The first base layer serves as the foundational image upon which the containerized applications run. The first base layer may include an operating system, libraries, and dependencies for the containerized applications to function. In an embodiment of the disclosure, the at least one operational container 210 corresponds to one or more instances of containers that are currently running and actively executing the containerized applications or services. The at least one operational container 210 is an active environment where the containerized applications reside, utilizing the base layers that are to be updated. Further, the trigger corresponds to an event or condition that initiates the process of updating the first base layer of the at least one operational container 210. For example, the trigger may be generated via a set of sources, such as a user request, a scheduled update, performance metrics, and the like. In an embodiment of the disclosure, the system 202 receives the user request from the user device 204. Details on the set of sources have been explained with reference to at least FIG. 3.

Further, the system 202 is configured to import the at least one operational container 210 in a replacement memory of at least one containerization system 212 based on the detection of the trigger. In an embodiment of the disclosure, the replacement memory corresponds to a logical memory within the at least one containerization system 212. In an embodiment of the disclosure, the at least one containerization system 212 is a platform that automates the deployment, management, scaling, and networking of the containerized applications. For example, the at least one containerization system 212 may be Kubernetes®.

Further, the system 202 is configured to import a second base layer of the at least one operational container 210 in the replacement memory based on the importation of the at least one operational container 210 in the replacement memory. In an embodiment of the disclosure, the second base layer corresponds to a new or updated version of the base layer of the at least one operational container 210 that is intended to replace the first base layer. The second base layer may include enhancements, security patches, or new features that improve the performance or security of the containerized applications.

Furthermore, the system 202 is configured to associate the second base layer with a container filesystem of the at least one operational container 210 based on the importation of the second base layer in the replacement memory. In an embodiment of the disclosure, the second base layer includes the updated files, libraries, and dependencies that the containerized applications use to run, seamlessly. By associating the second base layer with the container filesystem, the system 202 ensures that the at least one operational container 210 can access and use the second base layer. In an embodiment of the disclosure, the container filesystem is the structured environment within the at least one operational container 210 that holds the files and directories used for running the containerized applications. Further, the system 202 is configured to update the first base layer with the second base layer based on the association of the second base layer. Updating of the first base layer with the second base layer is performed to run the operational container on the latest and a secure version of its foundational components.

In an embodiment of the disclosure, each of the user device 204, the computing server 206, and the storage unit 208 is connected independently to the system 202 using the WAN 104, such as 5G, 6G, and future wireless networks. This individual connectivity performs seamless and efficient data exchange between the system 202 and each of the user device 204, the computing server 206, and the storage unit 208, allowing for real-time communication and the timely updating of data. By leveraging advanced wireless technologies such as 5G, 6G, and future networks, the system 202 can accommodate data throughput, ensuring that layer updating processes are executed without delay resulting in reliability. As a result, the system 202 handles large volumes of data packets efficiently, supports concurrent connections from multiple endpoints, and maintains data integrity during transmission, thereby optimizing the performance of distributed applications and enhancing the overall responsiveness of an architecture of the system 202.

Further, the user device 204 includes suitable logic, circuitry, interfaces, and/or code configured to input and transmit the user request to the system 202, for updating the first base layer. In an embodiment of the disclosure, the user device 204 is associated with a user. The user uses the user device 204 to input and transmit the user request to the system 202. For example, the user may be a system administrator, a software developer, a cloud service provider, a cybersecurity professional, and the like. Further, the user device 204 ensures efficient communication with the system 202 through connectivity technologies like WAN, thereby supporting timely and secure data exchange. The user device 204 is communicatively coupled with the system 202 via the WAN 104. In an embodiment of the disclosure, the user device 204 is an exemplary embodiment of the EUD 106. Examples of the user device 204 may include, but are not limited to, a computing device, a smartphone, a mainframe machine, a server, a computer workstation, a cellular phone, a mobile phone, a gaming device, a consumer electronic (CE) device, a desktop computer, a laptop, a head-mounted device (HMD), and/or any additional electronic device. In an embodiment of the disclosure, the system 202 is implemented in the computing server 206. In an embodiment of the disclosure, the system 202 is implemented in the user device 204.

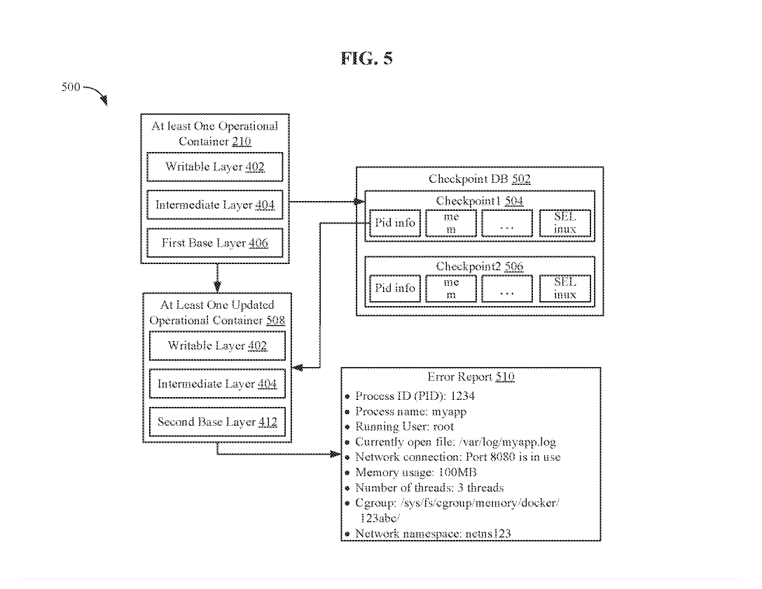

In an embodiment of the disclosure, a display screen of the user device 204 may include suitable logic, circuitry, and interfaces configured to receive the user request. Further, the display screen provides a user-friendly interface where a user may input the user request for updating the first base layer. The display screen may also be configured to display an error report. In an embodiment of the disclosure, the display screen may refer to a display screen of the smartphone, a display screen of the laptop, a display screen of the desktop computer, a display screen of a smart-glass device, a see-through display, a projection-based display, an electro-chromic display, or a transparent display. In an embodiment of the disclosure, the display screen is realized through several known technologies such as, but are not limited to, a Liquid Crystal Display (LCD) display, a Light Emitting Diode (LED) display, a plasma display, or an Organic LED (OLED) display technology, or additional display devices. Details about the error report have been explained with reference to at least FIG. 3 and FIG. 5.

In an embodiment of the disclosure, the computing server 206 is implemented as a cloud server and may execute operations through web applications, cloud applications, HTTP requests, repository operations, file transfer, and the like. Further, exemplary implementations of the computing server 206 include, but are not limited to, a database server, a file server, a web server, a media server, an application server, a mainframe server, or a cloud computing server.

In an embodiment of the disclosure, the computing server 206 is implemented as a plurality of distributed cloud-based resources by use of several technologies that are well known to those ordinarily skilled in the art. A person with ordinary skill in the art will understand that the scope of the disclosure may not be limited to the implementation of the computing server 206 and the system 202 as two separate entities. In certain embodiments, the functionalities of the computing server 206 can be incorporated in its entirety or at least partially in the system 202, without a departure from the scope of the disclosure.

In an embodiment of the disclosure, the storage unit 208 is configured to store an organized collection of data. The organized collection of data can be accessed electronically from a computer system (such as the system 202). In an embodiment of the disclosure, the storage unit 208 is communicatively coupled to the user device 204. The storage unit 208 communicatively coupled to the user device 204 is configured to store various types of data related to the integration process. For example, the storage unit 208 securely stores the user request, the error report, and container information of the at least one operational container 210. Details on the container information have been explained with reference to at least FIG. 3 and FIG. 5.

In an embodiment of the disclosure, the storage unit 208 is communicatively coupled to the system 202 via the WAN 104. The storage unit 208 communicatively coupled to the system 202 stores data generated during the integration processes. The storage unit 208 enhances the capacity of the system 202 to archive the integration command, the patch metadata information, the reserved layer content, or any combination thereof. By leveraging the storage unit 208, the system 202 may be able to manage larger volumes of data effectively. Further, the storage unit 208 is designed to manage, store, retrieve, and update data efficiently. The structure of the storage unit 208 involves tables, records, and fields that can be managed through various database management systems (DBMS). Examples of the storage unit 208 unit may include, but are not limited to, a relational database, a Non- Structured Query Language (SQL) database, a hierarchical database, a network database, a transactional database, a data warehouse, a distributed database, and a data lake.

In an embodiment, the system 202 may be a software framework that is configured to deploy, manage, and scale the containerized applications. The system 202 provides a consistent runtime environment by encapsulating the containerized application and its dependencies within the containers, ensuring seamless operation across various computing environments. Further, the system 202 may offer tools and services for the at least one containerization system 212, optimizing resource utilization, and automating tasks such as scaling and fault tolerance. Examples of different types of the system 202 include the at least one containerization system 212 (such as the Kubernetes®, docker, OpenShift®, and the like).

The system 202 may include the at least one containerization system 212, and a confidential virtual machine 214. For the sake of brevity, the system 202 is shown to include the confidential virtual machine 214 in FIG. 2, in actual implementation the system 202 may include a plurality of confidential virtual machine that may or may not be identical to the confidential virtual machine 214. The confidential virtual machine 214 may correspond to secure and isolated environments for the at least one operational container 210 within a pod 216, ensuring that the at least one operational container 210 shares the same security context and resources while being protected from various pods on the same host (e.g., the confidential virtual machine 214), thereby maintaining confidentiality, integrity, and authenticity of data and processes.

In an embodiment, the confidential virtual machine 214 may include a kubelet 218, and a container runtime 220. The kubelet 218 may correspond to an agent installed on the confidential virtual machine 214. The kubelet 218 may be configured to manage the lifecycle of pods such as scheduling the at least one operational container 210 for execution, updating container images, reporting a health status of the at least one operational container 210, and handling failures or restarts of the at least one operational container 210. In an embodiment, the kubelet 218 may be further configured to generate a container runtime interface (CRI) request to communicate with the container runtime 220. In an embodiment, the kubelet 218 may communicate with the container runtime 220 through a plugin interface (e.g., a container runtime interface) that allows the kubelet 218 to interact with the container runtime 220 without requiring recompilation of various components.

The container runtime 220 may correspond to a software component that may be installed on the confidential virtual machine 214 to execute and manage operations such as the execution of the at least one operational container 210. Examples of the container runtime 220 may include docker, container, or container runtime interface – open (CRI-O). In an embodiment, the container runtime 220 may include a container management service 222. The container management service 222 may be configured to manage and orchestrate container lifecycle operations within the confidential virtual machine 214. The container management service 222 may handle low-level operations that may be recommended for initialization, execution, and monitoring of the at least one operational container 210.

In an embodiment of the disclosure, the system 202 includes the at least one containerization system 212. The at least one containerization system 212 includes the replacement memory. In an embodiment of the disclosure, the system 202 imports the at least one operational container 210 and the second base layer into the replacement memory.

In operation, the system 202 is configured to detect the trigger indicating a requirement to update the first base layer of the at least one operational container 210. In an embodiment of the disclosure, the trigger may be generated via the set of sources, such as the user request, the scheduled update, the performance metrics, and the like. In an embodiment of the disclosure, the system 202 configures the replacement memory within the at least one operational container 210 based on the detection of the trigger, such that the at least one operational container 210 can be safely updated without affecting its live operations. When the replacement memory is configured, the system 202 is configured to import the at least one operational container 210 into the replacement memory. Details on configuring the replacement memory within the at least one operational container 210 have been explained with reference to at least FIG. 3.

Further, the system 202 is configured to import the second base layer (an updated version of the first base layer) into the replacement memory. The importation of the second base layer ensures that the second base layer is available for updating the first base layer. Furthermore, the system 202 is configured to associate the second base layer with the container filesystem of the at least one operational container 210 based on the importation of the second base layer in the replacement memory. By associating the second base layer with the container filesystem, the system 202 ensures that the at least one operational container 210 can access and use the second base layer. Further, the system 202 is configured to update the first base layer with the second base layer based on the association of the second base layer. This update is performed seamlessly, ensuring that the at least one operational container 210 continues to operate without interruption.

FIG. 3 is a diagram that illustrates exemplary operations of the system 202 for updating the base layer of the containers, in accordance with an embodiment of the disclosure. FIG. 3 is explained in conjunction with elements from FIG. 1 and FIG. 2. With reference to FIG. 3, there is shown a block diagram 300 that illustrates exemplary operations from 302 to 316, as described herein. The exemplary operations illustrated in the block diagram 300 start at 302 and are performed by any computing system, apparatus, or device, such as by the computer 102 of FIG. 1 or system 202 of FIG. 2. Although illustrated with discrete blocks, the exemplary operations associated with one or more blocks of the block diagram 300 are divided into additional blocks, combined into fewer blocks, or eliminated, depending on the particular implementation.

At 302, a trigger detection operation is executed. In the trigger detection operation, the system 202 is configured to detect the trigger to update the first base layer of the at least one operational container 210. For example, the trigger may be generated via the set of sources, such as the user request, the scheduled update, the performance metrics, and the like. In an embodiment of the disclosure, the system 202 receives the user request from the user device 204. For example, an administrator may submit a command via the user device 204 to update the first base layer due to newly available security patches or performance enhancements. Further, the trigger may be a scheduled task that automatically checks for updates at regular intervals. If the system 202 detects that a new version of the first base layer is available, the system 202 can initiate the process of updating the first base layer without manual intervention. The system 202 is also configured to monitor the performance metrics of the application running in the container. When the system 202 detects a significant drop in performance that correlates with the first base layer, the system 202 generates a trigger to update the first base layer.

At 304, a memory configuration operation is executed. In the memory configuration operation, the system 202 is configured to configure the replacement memory in the at least one containerization system 212 based on the detection of the trigger. The replacement memory is a temporary environment designed to store and manage the at least one operational container 210, such that the update of the first base layer of the at least one operational container 210 is performed without disrupting the ongoing operations of the at least one operational container 210.

At 306, a container importation operation is executed. In the container importation operation, the system 202 is configured to import the at least one operational container 210 in the replacement memory of the at least one containerization system 212 based on the detection of the trigger. In the container importation operation, the at least one operational container 210 is transmitted from a source location (e.g., a container registry) into the replacement memory. In an embodiment of the disclosure, a current state of the at least one operational container 210, environment variables of the at least one operational container 210, and runtime data of the at least one operational container 210 are imported to the replacement memory. As a result, the at least one operational container 210 retains its operational context during the update. Further, container images (e.g., base images of the at least one operational container 210 and parent images of the at least one operational container 210) associated with the at least one operational container 210 are also imported to the replacement memory.

During the container importation operation, the at least one containerization system 212 uses an isolation process to ensure that update operations of the at least one operational container 210 in the replacement workspace do not interfere with a normal operation of the at least one operational container 210. The normal operation of the at least one operational container 210 corresponds to a state in which the at least one operational container 210 is functioning and executing its designated tasks without interruptions or errors. For example, in the isolation process, the at least one operational container 210 may be set to a read-only mode, preventing any changes to its state while the update operation is performed. This ensures that the data associated with the at least one operational container 210 remains consistent and unaffected by the update operations.

At 308, a layer importation operation is executed. In the layer importation operation, the system 202 is configured to import the second base layer of the at least one operational container 210 in the replacement memory based on the importation of the at least one operational container 210 in the replacement memory. When the second base layer is in the replacement memory, the second base layer is stored in a container space. The container space is a storage area managed by the at least one containerization system 212, where image layers of container images are stored. Further, the container space allows the at least one containerization system 212 to manage and access the image layers that make up the container images. By storing the second base layer in the container space, the system 202 prepares the second base layer for the process of updating the first base layer.

At 310, a layer association operation is executed. In the layer association operation, the system 202 is configured to associate the second base layer with the container filesystem of the at least one operational container 210 based on the importation of the second base layer in the replacement memory. In an embodiment of the disclosure, the layer association operation is performed using a container driver interface of the at least one operational container 210. In an embodiment of the disclosure, the container driver interface acts as an intermediary between the container filesystem and a storage system associated with the at least one operational container 210. Further, the container driver interface is configured to dynamically mount the second base layer to the container filesystem of the at least one operational container 210. For dynamically mounting the second base layer, the container driver interface attaches the second base layer to the container filesystem of the at least one operational container 210 in real-time, without stopping or restarting the at least one operational container 210. This layer association operation is performed to maintain the uptime of the applications and ensure that the applications remain operational during the updates.

At 312, a layer modification operation is executed. In the layer modification operation, the system 202 is configured to update the first base layer with the second base layer based on the association of the second base layer. The update of the first base layer includes replacing first data associated with the first base layer with second data associated with the second base layer. For example, the layer modification operation may be performed to at least one of update the configurations of the first base layer, adding new features to the first base layer, or fixing issues of the first base layer.

In the layer modification operation, the system 202 is configured to remove at least one first link between the first base layer and a set of parent layers associated with the first base layer. In an embodiment of the disclosure, the at least one first link is removed based on the association of the second base layer. Further, the system 202 is configured to establish at least one second link based on the removal of the at least one first link. In an embodiment of the disclosure, the at least one second link is between the second base layer and the set of parent layers.

At 314, a metadata modification operation is executed. In the metadata modification operation, the system 202 is configured to update first metadata of the first base layer with second metadata of the second base layer. In an embodiment of the present disclosure, the first metadata of the first base layer is updated based on the update of the first base layer. For example, the metadata modification operation includes changing a version number of the first base layer, updating layer dependency information of the first base layer, and the like. The update of the first metadata is performed to maintain an integrity and functionality of the at least one operational container 210. By ensuring that metadata of the at least one operational container 210 is current and accurate, the system 202 can effectively manage a lifecycle of the at least one operational container 210, perform troubleshooting of the at least one operational container 210, and ensure compatibility of the at least one operational container 210 with components or services interacting with the at least one operational container 210.

In an embodiment of the disclosure, the metadata modification operation includes obtaining a different (diff) content from the second base layer and overwriting corresponding parts of the first base layer with the different content. In an embodiment of the disclosure, the different content represents one or more changes between two versions of a file or image layer in a container. For example, the one or more changes may include modifications, additions, or deletions that have occurred when comparing the second base layer with the first base layer. The update process is performed in the background of the at least one operational container 210. As a result, it does not require the at least one operational container 210 to stop or restart. Thus, the service availability is maintained, especially in production environments where uptime is valuable for the organizations. By executing the update in the background, the at least one operational container 210 can continue to operate normally while the one or more changes are being applied to it. During the metadata modification operation, the container filesystem is managed to ensure that it properly maps to the second base layer. This involves maintaining the integrity of the container filesystem, such that the at least one operational container 210 can access files and resources without interruption. The system ensures that the one or more changes do not affect a runtime state of the at least one operational container 210, meaning that the applications running within the at least one operational container 210 remain unaffected by the update process. Further, a current file system view of the at least one operational container 210 remains intact during the metadata modification operation. This means that any processes or applications accessing files in the at least one operational container 210 may continue to see the same files and directories that the processes or applications may be using before the metadata modification operation.

At 316, a layer removal operation is executed. In the layer removal operation, the system 202 is configured to remove the first base layer from the container filesystem based on the update of the first metadata. In an embodiment of the disclosure, the first base layer is removed because the first base layer is no longer valid or relevant due to the one or more changes that are applied to the first base layer. By removing the first base layer, the container filesystem is effectively cleaned up to ensure that only the most current and relevant layers are present, which helps optimize the storage and performance of the at least one operational container 210.

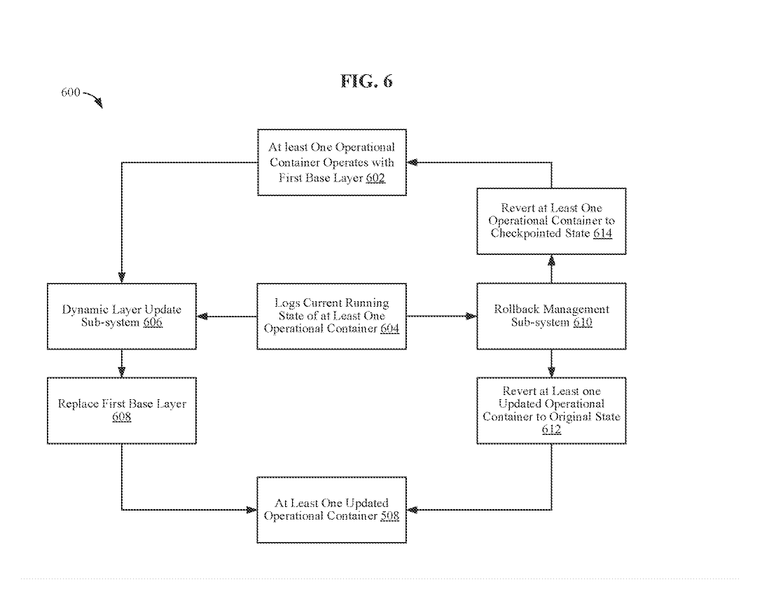

Further, the system 202 is configured to detect one or more issues associated with the update of the first base layer with the second base layer. In an embodiment of the disclosure, the one or more issues may disrupt the update or affect the performance of the at least one operational container 210. For example, the one or more issues may include compatibility problems between the second base layer and the first base layer, missing dependencies in the second base layer, conflicts with running applications, and the like. Furthermore, the system 202 is configured to generate an error report based on the detection of the one or more issues. For example, the error report includes a summary of the update of the first base layer with the second base layer, the one or more issues, a set of error codes associated with the one or more issues, and one or more actionable insights for resolving the one or more issues. In an embodiment of the disclosure, the set of error codes corresponds to identifiers assigned to the one or more issues encountered during the update process of the first base layer with the second base layer. The set of error codes serves as a standardized way to categorize and communicate the nature of the problems. Each error code of the set of error codes corresponds to a particular type of issue, such as a compatibility error, a missing dependency, or a configuration conflict. Further, the one or more actionable insights are recommendations that users can use to resolve the one or more issues. For example, the one or more actionable insights may include rolling back to the previous version of the base layer, modifying configuration settings, and the like. The system 202 is configured to output the error report on the user device 204. For example, the output may be a notification on a dashboard, an email alert, a message in a logging system, and the like. Details about the one or more issues are provided, for example, in FIG. 6.

In an embodiment of the disclosure, a rollback mechanism is performed when the one or more issues are detected during or after updating the first base layer with the second base layer. In the rollback mechanism, the system 202 restores the parent layer relationship to the first base layer, ensuring the stability and continued operation of the at least one operational container 210. For restoring the parent layer relationship to the first base layer, the system 202 is configured to obtain container information of the at least one operational container 210. For example, the container information of the at least one operational container 210 includes at least one of a process identifier of the at least one operational container 210, a name of the at least one operational container 210, a user identifier associated with a user of the at least one operational container 210, a file associated with the at least one operational container 210, network connection information of the at least one operational container 210, a memory usage information of the at least one operational container 210, thread information associated with the at least one operational container 210, a network namespace associated with the at least one operational container 210, a process tree associated with the at least one operational container 210, a file descriptor of the at least one operational container 210, a control group of the at least one operational container 210, a run time information of the at least one operational container 210, or security context information of the at least one operational container 210.

In an embodiment of the disclosure, the network connection information includes the details about the network interfaces and connections that the at least one operational container 210 is using. For example, the network connection information includes the IP address assigned to the at least one operational container 210, the ports that are open for communication, and the protocols being used (e.g., Transmission Control Protocol or User Datagram Protocol). Further, the memory usage information provides insights into how much memory the at least one operational container 210 consumes during its execution. The thread information includes the information associated with threads that are active within the at least one operational container 210. The thread information includes details about the number of threads, the states of the threads (e.g., running, waiting, or blocked), and the resource consumption of the threads. The network namespace is a feature that provides isolation for network resources. Each container can have its network namespace, which means it has its network stack, including interfaces, routing tables, and firewall rules. Furthermore, the process tree represents the hierarchy of processes running within the at least one operational container 210. The process tree shows how processes are related to one another, including parent-child relationships. The file descriptor is a unique identifier for an open file or resource within the at least one operational container 210. The file descriptor allows processes to read from or write to files, sockets, or Input/Output resources. Further, the control group (cgroup) is a Linux kernel feature that allows the allocation and management of resources (such as CPU, memory, and Input/Output) for groups of processes. The runtime information encompasses various metrics related to the execution of the at least one operational container 210, including its start time, uptime, and performance statistics. Furthermore, the security context information includes details about the security settings and policies applied to the at least one operational container 210.

Further, the system 202 is configured to update a state of the at least one operational container 210 based on the container information and the one or more issues. In an embodiment of the disclosure, the rollback mechanism is triggered for updating the state of the at least one operational container 210. The rollback mechanism reverts the at least one operational container 210 to its previous state by restoring the parent layer relationship to the first base layer. Thus, the at least one operational container 210 can maintain stability and continue operating without interruption. The rollback mechanism not only mitigates the impact of the encountered issues but also allows for a seamless recovery, enabling the at least one operational container 210 to function as intended while the underlying problems are addressed. Thus, updating the state in this context is a proactive measure to ensure operational continuity and reliability in containerized environments.

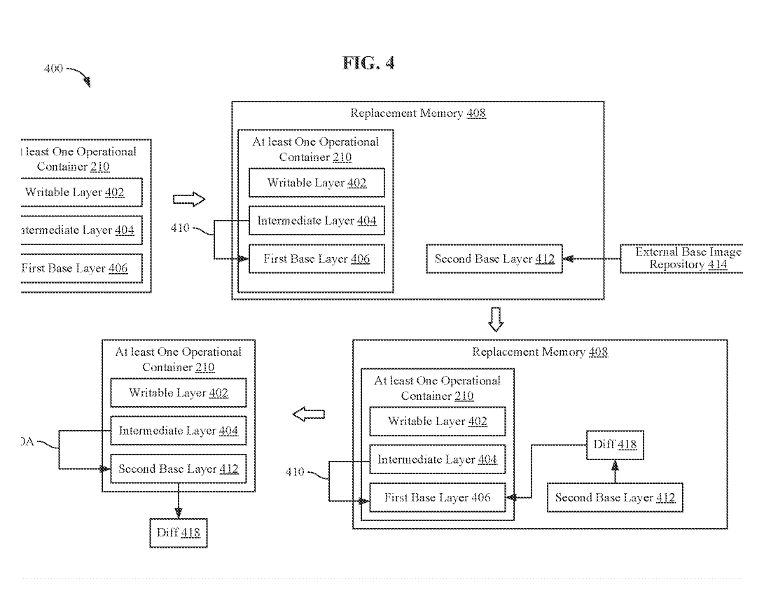

FIG. 4 is a diagram that illustrates exemplary operations for updating the base layer of the containers, in accordance with an embodiment of the disclosure. FIG. 4 is explained in conjunction with elements from FIG. 1, FIG. 2, and FIG. 3.

As shown in a diagram 400 of FIG. 4, the at least one operational container 210 includes a writable layer 402, an intermediate layer 404, and a first base layer 406. For example, the writable layer 402 is the topmost layer where changes made during runtime are stored. Further, the intermediate layer 404 corresponds to a layer including additional modifications or dependencies. The first base layer 406 is a foundational layer that serves as the starting point for the container. For example, the first base layer 406 is nginx:1.2. Further, the at least one operational container 210 is imported into the replacement memory 408 within the at least one containerization system 212. In an embodiment of the disclosure, a link (e.g., the at least one first link 410) is established between the first base layer 406 and intermediate layer 404.

Further, the second base layer 412 is imported into the replacement memory 408 from an external base image repository 414A. In an embodiment of the disclosure, the second base layer 412 is associated with the container filesystem of the at least one operational container 210 by linking the second base layer 412 to the existing container layers of the at least one operational container 210. For example, the second base layer 412 is nginx:1.4. Further, a difference (diff) operation is performed between the first base layer 406 and the second base layer 412 to identify differences between them. In an embodiment of the disclosure, a diff 418 corresponds to one or more changes between the second base layer 412 and the first base layer 406. For example, the diff 418 includes the modifications, enhancements, or features that the second base layer 412 introduces to the at least one operational container 210. In an embodiment of the disclosure, the diff 418 is applied to the first base layer 406. Accordingly, the one or more updates of the second base layer 412 are copied or overridden to the first base layer 406 to ensure compatibility of the second base layer 412 with the existing container layers of the at least one operational container 210. Furthermore, the second base layer 412 replaces the first base layer 406 in the container filesystem, completing the update process of the first base layer 406. In an embodiment of the disclosure, a link (e.g., the at least one second link 410A) is established between the second base layer 412 and intermediate layer 404.

FIG. 5 is a diagram that illustrates exemplary operations for updating a state of the at least one operational container 210, in accordance with an embodiment of the disclosure. FIG. 5 is explained in conjunction with elements from FIG. 1, FIG. 2, FIG. 3 and FIG. 4.

As shown in a diagram 500, the system 202 uses Checkpoint/Restore in Userspace (CRIU) technology to record the state (e.g., a runtime state) of the at least one operational container 210 before updating the at least one operational container 210. In an embodiment of the disclosure, a checkpoint Database 502 (DB) stores snapshots of the runtime state of the at least one operational container 210. For example, the snapshots include the container information, such as process information, memory usage, and security context. These snapshots are labeled as checkpoint1 504 and checkpoint2 506. 508 represents the at least one operational container 210 after the first base layer 406 is dynamically updated (hereinafter called at least one updated operational container 508).

In an embodiment of the disclosure, the system 202 dynamically updates the at least one operational container 210 by replacing the first base layer 406 with the second base layer 412 while maintaining the runtime state of the at least one operational container 210. If the one or more issues occur during the update of the at least one operational container 210, the system 202 can perform the rollback mechanism and restore the at least one operational container 210 to its previous state using the snapshots stored in the checkpoint DB 502. This ensures minimal downtime and preserves the functionality of the at least one operational container 210. For example, the downtime is considered minimal if the downtime does not exceed a threshold time period (say 5 seconds) during the update process. After updating the first base layer 406 or performing the rollback mechanism, the system 202 generates the error report 510 summarizing the running state of the at least one operational container 210. Further, command outputs (e.g., ps aux, cat /proc/...) provide detailed runtime information about the at least one operational container 210, such as process tree, memory mappings, and resource usage. In an embodiment of the disclosure, the error report 510 provides actionable insights into the runtime state of the at least one operational container 210, helping administrators understand the scope of the update process or the rollback mechanism.

FIG. 6 is a diagram that illustrates a flowchart for updating the base layer of the containers, in accordance with an embodiment of the disclosure. FIG. 6 is explained in conjunction with elements from FIG. 1, FIG. 2, FIG. 3, FIG. 4, and FIG. 5.

As shown in the flowchart 600, at 602, the at least one operational container 210 operates with the first base layer 406 and has active processes, configurations, and data. Before the first base layer 406 is updated, the system logs the current running state of the at least one operational container 210, at 604. In an embodiment of the disclosure, a dynamic layer update sub-system 606 of the system 202 logs the current running state of the at least one operational container 210. This includes creating a checkpoint that captures the container filesystem, running processes and their states, and metadata (e.g., resource usage and configurations). The checkpoint serves as a backup, enabling the system 202 to revert to the original runtime state if the update fails or causes the one or more issues.

Further, the dynamic layer update sub-system 606 of the system 202 performs a set of operations for managing the update process of the at least one operational container 210. The set of operations includes detecting triggers for updating the first base layer 406 (e.g., second base layer availability), initiating the replacement of the first base layer 406, recording the status of the update process for monitoring and reporting purposes, and the like. At 608, the system 202 replaces the first base layer 406 of the at least one operational container 210 with the second base layer 412. After the first base layer 406 is successfully replaced with the second base layer 412, the at least one operational container 210 transitions into a dynamically updated state. The at least one operational container 210 in the dynamically updated state is called the at least one updated operational container 508. In an embodiment of the disclosure, the at least one updated operational container 508 operates with the second base layer 412 while retaining its previous runtime configurations and processes.

Further, if the one or more issues are detected during or after the update process, a rollback management sub-system 610 of the system 202 uses the previously logged checkpoint to revert the at least one updated operational container 508 to its original state, at 612. This results in minimal downtime and prevents data loss or corruption. At 614, the system 202 reverts the at least one operational container 210 to a checkpointed state of the at least one operational container 210, effectively undoing the update. This ensures that the at least one operational container 210 can continue operating without disruptions caused by the failed update.

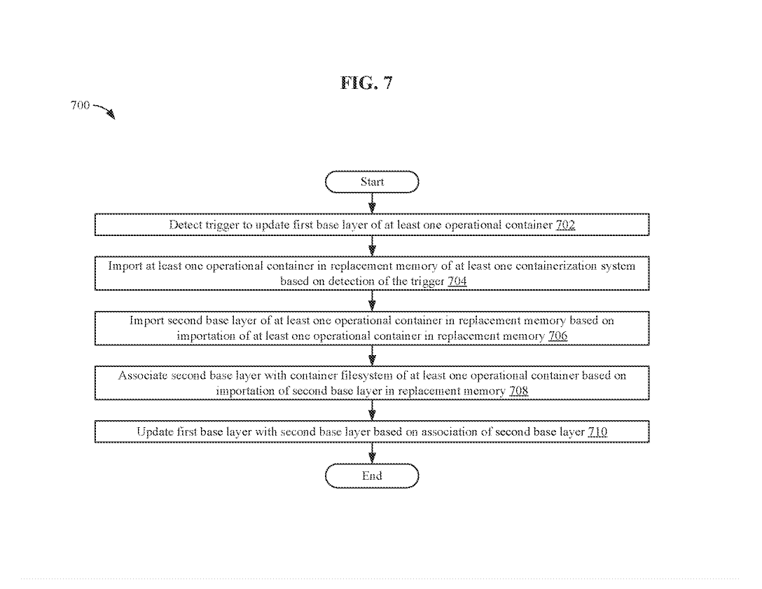

FIG. 7 is a diagram that illustrates a first flowchart of an exemplary method for updating the base layer of the containers, in accordance with an embodiment of the disclosure. FIG. 7 is explained in conjunction with elements from FIG. 1, FIG. 2, FIG. 3, FIG. 4, FIG. 5, and FIG. 6. The operations of the exemplary computer-implemented method are executed by any computing system, for example, by the computer 102 of FIG. 1 or the system 202 of FIG. 2. The operations of a first flowchart 700 may start at 702.

At 702, a trigger is detected to update a first base layer 406 of at least one operational container 210. In an embodiment of the disclosure, the system 202 is configured to detect the trigger to update the first base layer 406 of the at least one operational container 210. The trigger may be initiated by multiple factors, such as a scheduled update, a security vulnerability alert, or a new feature release. The detection mechanism is used to ensure that the updates are timely and relevant, preventing potential issues that may arise from outdated software. The system continuously monitors the trigger to maintain defined performance and security. Details about the detection of the trigger are provided, for example, in FIG. 3.

At 704, the at least one operational container 210 is imported in a replacement memory 408 of at least one containerization system 212 based on the detection of the trigger. In an embodiment of the disclosure, the system 202 is configured to import the at least one operational container 210 in the replacement memory 408 of the at least one containerization system 212 based on the detection of the trigger. This involves temporarily storing the at least one operational container 210 in a designated area of memory (e.g., the replacement memory 408) that is separate from the main operational environment. The replacement memory 408 allows for manipulation of the at least one operational container 210 without affecting the currently running instance of the at least one operational container 210. By isolating the at least one operational container 210, the system 202 can prepare for the update of the first base layer 406 while ensuring that the existing operations of the at least one operational container 210 continue uninterrupted. Details about the importation of the at least one operational container 210 are provided, for example, in FIG. 3.

At 706, a second base layer 412 of the at least one operational container 210 is imported in the replacement memory 408 based on the importation of the at least one operational container 210 in the replacement memory 408. In an embodiment of the disclosure, the system 202 is configured to import the second base layer 412 of the at least one operational container 210 in the replacement memory 408 based on the importation of the at least one operational container 210 in the replacement memory 408. The second base layer 412 includes the updated software or configuration that needs to be applied to the at least one operational container 210. In an embodiment of the disclosure, the second base layer 412 is imported into the replacement memory 408 where the operational container resides, allowing for a seamless transition. As a result, the second base layer 412 is ready to be associated with the at least one operational container 210 before any changes are made to the at least one operational container 210. Details about the importation of the second base layer 412 are provided, for example, in FIG. 3.

At 708, the second base layer 412 is associated with a container filesystem of the at least one operational container 210 based on the importation of the second base layer 412 in the replacement memory 408. In an embodiment of the disclosure, the system 202 is configured to associate the second base layer 412 with the container filesystem of the at least one operational container 210 based on the importation of the second base layer 412 in the replacement memory 408. In an embodiment of the present disclosure, the association is used for linking the second base layer 412 to the container filesystem, effectively preparing the first base layer 406 for the update. The association ensures that when the update of the first base layer 406 occurs, the at least one operational container 210 may reference the second base layer 412 instead of the first base layer 406. As a result, the integrity of the container filesystem is maintained and components of the at least one operational container 210 work together correctly after the update of the first base layer 406. Details on associating the second base layer 412 with the container filesystem are provided, for example, in FIG. 3.

At 710, the first base layer 406 is updated with the second base layer 412 based on the association of the second base layer 412. In an embodiment of the disclosure, the system 202 is configured to update the first base layer 406 with the second base layer 412 based on the association of the second base layer 412. In an embodiment of the disclosure, the system 202 replaces the first base layer 406 with the second base layer 412, effectively refreshing the at least one operational container 210 with the latest software or configurations. This update is performed, such that disruption to the at least one operational container 210 is minimized, allowing the at least one operational container 210 to continue functioning while the changes are applied. As a result, the users experience minimal downtime during the update process. Details on updating the first base layer 406 with the second base layer 412 are provided, for example, in FIG. 3, FIG. 4, FIG. 5, and FIG. 6.

While the above operation of the system 202 shown in FIG. 7 is described in a particular sequence, the operation of the system 202 may occur in variations to the sequence in accordance with various embodiments of the disclosure. Further, details related to the operation of FIG. 7, which are already covered in the description related to FIG. 1 to FIG. 6 are not discussed again in detail here for the sake of brevity.

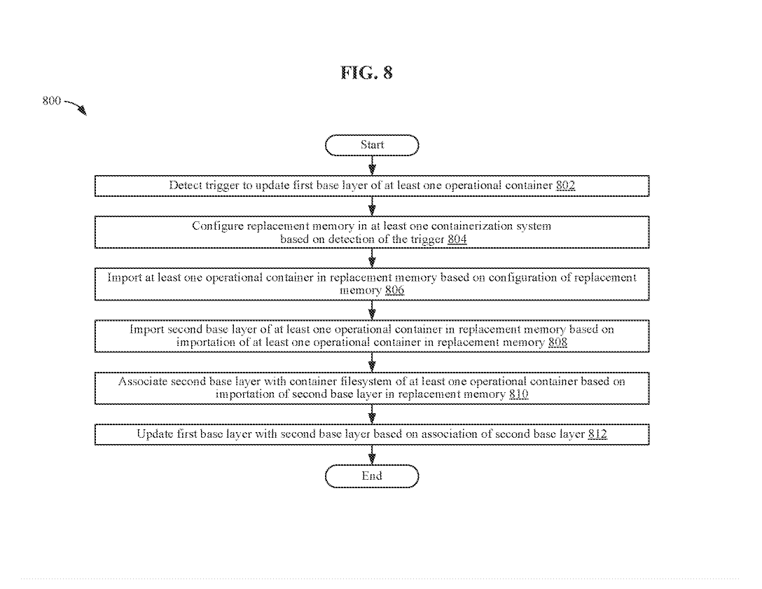

FIG. 8 is a diagram that illustrates a second flowchart of an exemplary method updating the base layer of the containers, in accordance with an embodiment of the disclosure. FIG. 8 is explained in conjunction with elements from FIG. 1, FIG. 2, FIG. 3, FIG. 4, FIG. 5, FIG. 6, and FIG. 7. The operations of the exemplary computer-implemented method are executed by any computing system, for example, by the computer 102 of FIG. 1 or the system 202 of FIG. 2. The operations of a second flowchart 800 may start at 802.

At 802, a trigger is detected to update a first base layer 406 of at least one operational container 210. In an embodiment of the disclosure, the system 202 is configured to detect the trigger to update the first base layer 406 of the at least one operational container 210. The trigger may be initiated by multiple factors, such as a scheduled update, a security vulnerability alert, or a new feature release. The detection mechanism is used to ensure that the updates are timely and relevant, preventing potential issues that may arise from outdated software. The system 202 continuously monitors the trigger to maintain performance and security. Details about the detection of the trigger are provided, for example, in FIG. 3.

At 804, a replacement memory 408 is configured in at least one containerization system 212 based on the detection of the trigger. In an embodiment of the disclosure, the system 202 is configured to configure the replacement memory 408 in at least one containerization system 212 based on the detection of the trigger. In an embodiment of the disclosure, the replacement memory 408 serves as a temporary storage area where the at least one operational container 210 and the second base layer 412 can be manipulated without affecting the live environment. This configuration may involve allocating sufficient memory resources and setting up the environment to import the at least one operational container 210 and the second base layer 412. The goal is to create a safe space for updates, ensuring that an existing container (e.g., a running instance of the at least one operational container 210) continues to operate without interruption. Details about configuring the at least one operational container 210 are provided, for example, in FIG. 3.

At 806, the at least one operational container 210 is imported into the replacement memory 408 based on the configuration of the replacement memory 408. In an embodiment of the disclosure, the system 202 is configured to import the at least one operational container 210 in the replacement memory 408 based on the configuration of the replacement memory 408. This involves temporarily storing the at least one operational container 210 in a designated area of memory (e.g., the replacement memory 408) that is separate from the main operational environment. The replacement memory 408 allows for manipulation of the at least one operational container 210 without affecting the currently running instance of the at least one operational container 210. By isolating the at least one operational container 210, the system 202 can prepare for the update of the first base layer 406 while ensuring that the existing operations of the at least one operational container 210 continue uninterrupted. Details on importing the at least one operational container 210 are provided, for example, in FIG. 3.

At 808, a second base layer 412 of the at least one operational container 210 is imported in the replacement memory 408 based on the importation of the at least one operational container 210 in the replacement memory 408. In an embodiment of the disclosure, the system 202 is configured to import the second base layer 412 of the at least one operational container 210 in the replacement memory 408 based on the importation of the at least one operational container 210 in the replacement memory 408. The second base layer 412 includes the updated software or configuration that needs to be applied to the at least one operational container 210. In an embodiment of the disclosure, the second base layer 412 is imported into the replacement memory 408 where the operational container resides, allowing for a seamless transition. As a result, the second base layer 412 is ready to be associated with the at least one operational container 210 before any changes are made to the at least one operational container 210. Details about the importation of the second base layer 412 are provided, for example, in FIG. 3.

At 810, the second base layer 412 is associated with a container filesystem of the at least one operational container 210 based on the importation of the second base layer 412 in the replacement memory 408. In an embodiment of the disclosure, the system 202 is configured to associate the second base layer 412 with the container filesystem of the at least one operational container 210 based on the importation of the second base layer 412 in the replacement memory 408. In an embodiment of the present disclosure, the association is used for linking the second base layer 412 to the container filesystem, effectively preparing the first base layer 406 for the update. The association ensures that when the update of the first base layer 406 occurs, the at least one operational container 210 may reference the second base layer 412 instead of the first base layer 406. As a result, the integrity of the container filesystem is maintained and components of the at least one operational container 210 work together correctly after the update of the first base layer 406. Details on associating the second base layer 412 with the container filesystem are provided, for example, in FIG. 3.

At 812, the first base layer 406 is updated with the second base layer 412 based on the association of the second base layer 412. In an embodiment of the disclosure, the system 202 is configured to update the first base layer 406 with the second base layer 412 based on the association of the second base layer 412. In an embodiment of the disclosure, the system 202 replaces the first base layer 406 with the second base layer 412, effectively refreshing the at least one operational container 210 with the latest software or configurations. This update is performed, such that disruption to the at least one operational container 210 is minimized, allowing the at least one operational container 210 to continue functioning while the changes are applied. As a result, the users experience minimal downtime during the update process. Details on updating the first base layer 406 with the second base layer 412 are provided, for example, in FIG. 3, FIG. 4, FIG. 5, and FIG. 6.

While the above operation of the system 202 shown in FIG. 8 is described in a particular sequence, the operation may occur in variations to the sequence in accordance with various embodiments of the disclosure. Further, details related to the operation of FIG. 8, which is already covered in the description related to FIG. 1 to FIG. 7 are not discussed again in detail here for the sake of brevity.

The system 202 presents multiple advantages. By enabling the dynamic replacement of the first base layer 406 while the at least one operational container 210 remains operational, the system 202 allows for continuous updates without service interruptions. This capability significantly improves system availability and stability, as users can receive updates, security patches, or feature enhancements without experiencing downtime. This is particularly used in environments where uptime is fundamental for business continuity. Once the second base layer 412 is successfully integrated with the first base layer 406, the system 202 automatically removes the first base layer 406. This process optimizes resource utilization efficiency by freeing up storage resources that are previously occupied. By freeing up the storage resources, the system 202 allows for better allocation of disk space and memory, which can lead to improved processing speeds and reduced latency in container orchestration environments.

Further, the introduction of replacement memory 408 and dynamic mounting of the second base layer 412 allows for flexible updates during the update process. This flexibility is used in scenarios that require frequent updates, such as applying security patches or implementing new features. The ability to adapt to changing requirements without significant overhead enhances the overall agility of the system 202. Utilizing technologies like CRIU provides a robust rollback capability. In the event of an update failure or unexpected issues, the system 202 can quickly restore the at least one operational container 210 to its previous running state. This ensures reliability and business continuity, allowing organizations to mitigate risks associated with updates and maintain operational integrity. Furthermore, the method includes mechanisms for detecting issues during the update process and generating detailed error reports. This feature not only aids in proactive issue resolution but also provides actionable insights for administrators. By having access to comprehensive container information, administrators can make informed decisions that enhance system performance and reliability.

The system 202 for updating the first base layer 406 of the at least one operational container 210 offers significant advantages in terms of memory, processor, and overall hardware efficiency. By leveraging the replacement memory 408, the system 202 minimizes the need for direct modifications to the at least one operational container 210, reducing the risk of memory fragmentation and ensuring memory utilization. The use of a temporary workspace (e.g., the replacement memory 408) allows the system 202 to isolate the update process, preventing memory overhead in a primary runtime environment. This isolation ensures that only the needed layers are loaded into memory, avoiding redundant data duplication and conserving memory resources. Further, the system 202 performs dynamic updating of container layers without requiring a complete restart of the at least one operational container 210. This efficiency means that the Central Processing Unit (CPU) can continue executing tasks without interruption, leading to better utilization of processing power and reducing idle time. By importing the at least one operational container 210 and the second base layer 412 into the replacement memory 408, the system 202 minimizes the time the CPU spends waiting for updates to be completed. This reduction in latency enhances the responsiveness of applications running within the containers, providing a smoother user experience. The system 202 can leverage multi-core CPU architectures effectively. Since the update process can occur in parallel with other operations, multiple cores can handle different tasks simultaneously, improving the overall throughput and performance of the system 202. This is particularly beneficial in environments where multiple containers are being managed concurrently.

In various embodiments of the disclosure, a computer program product for updating a first base layer of at least one operational container is described. The computer program product includes one or more computer-readable storage medium and program instructions stored on the one or more computer-readable storage media to perform operations. The operations include detecting a trigger to update the first base layer of the at least one operational container. The operations include importing the at least one operational container in a replacement memory of at least one containerization system based on the detection of the trigger. Further, the operations include importing a second base layer of the at least one operational container in the replacement memory based on the importation of the at least one operational container in the replacement memory. The operations include associating the second base layer with a container filesystem of the at least one operational container based on the importation of the second base layer in the replacement memory. The operations also include updating the first base layer with the second base layer based on the association of the second base layer.

The descriptions of the various embodiments of the disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
detecting, by a computer, a trigger to update a first base layer of at least one operational container;
importing, by the computer, the at least one operational container in a replacement memory of at least one containerization system based on the detection of the trigger;
importing, by the computer, a second base layer of the at least one operational container in the replacement memory based on the importation of the at least one operational container in the replacement memory;
associating, by the computer, the second base layer with a container filesystem of the at least one operational container based on the importation of the second base layer in the replacement memory; and
updating, by the computer, the first base layer with the second base layer based on the association of the second base layer.

2. The computer-implemented method of claim 1, further comprising:
configuring, by the computer, the replacement memory in the at least one containerization system based on the detection of the trigger.

3. The computer-implemented method of claim 1, further comprising:
removing, by the computer, at least one first link between the first base layer and a set of parent layers associated with the first base layer, wherein the at least one first link is removed based on the association of the second base layer; and
establishing, by the computer, at least one second link based on the removal of the at least one first link, wherein the at least one second link is between the second base layer and the set of parent layers.

4. The computer-implemented method of claim 1, further comprising:
updating, by the computer, first metadata of the first base layer with second metadata of the second base layer, wherein the first metadata of the first base layer is updated based on the update of the first base layer.

5. The computer-implemented method of claim 4, further comprising:
removing, by the computer, the first base layer from the container filesystem based on the update of the first metadata.

6. The computer-implemented method of claim 1, further comprising:
detecting, by the computer, one or more issues associated with the update of the first base layer with the second base layer;
generating, by the computer, an error report based on the detection of the one or more issues; and
outputting, by the computer, the error report on a user device.

7. The computer-implemented method of claim 6, wherein the error report comprises a summary of the update of the first base layer with the second base layer, the one or more issues, a set of error codes associated with the one or more issues, and one or more actionable insights for resolving the one or more issues.

8. The computer-implemented method of claim 6, further comprising:
obtaining, by the computer, container information of the at least one operational container; and
updating, by the computer, a state of the at least one operational container based on the container information and the one or more issues.

9. The computer-implemented method of claim 8, wherein the container information of the at least one operational container comprises at least one of a process identifier of the at least one operational container, a name of the at least one operational container, a user identifier associated with a user of the at least one operational container, a file associated with the at least one operational container, network connection information of the at least one operational container, a memory usage information of the at least one operational container, thread information associated with the at least one operational container, a network namespace associated with the at least one operational container, a process tree associated with the at least one operational container, a file descriptor of the at least one operational container, a control group of the at least one operational container, a run time information of the at least one operational container, or security context information of the at least one operational container.

10. The computer-implemented method of claim 1, wherein the replacement memory corresponds to a logical memory within the at least one containerization system.

11. A computer system, comprising:
a processor set;
one or more computer-readable storage media; and
program instructions stored on the one or more computer-readable storage media, the program instructions executable by the processor set to cause the processor set to:
detect a trigger to update a first base layer of at least one operational container;
configure a replacement memory in at least one containerization system based on the detection of the trigger;
import the at least one operational container in the replacement memory based on the configuration of the replacement memory;
import a second base layer of the at least one operational container in the replacement memory based on the importation of the at least one operational container in the replacement memory;
associate the second base layer with a container filesystem of the at least one operational container based on the importation of the second base layer in the replacement memory; and
update the first base layer with the second base layer based on the association of the second base layer.

12. The computer system of claim 11, wherein the program instructions further cause the processor set to:
remove at least one first link between the first base layer and a set of parent layers associated with the first base layer, wherein the at least one first link is removed based on the association of the second base layer; and
establish at least one second link based on the removal of the at least one first link, wherein the at least one second link is between the second base layer and the set of parent layers.

13. The computer system of claim 11, wherein the program instructions further cause the processor set to:
update first metadata of the first base layer with second metadata of the second base layer, wherein the first metadata of the first base layer is updated based on the update of the first base layer.

14. The computer system of claim 13, wherein the program instructions further cause the processor set to:
remove the first base layer from the container filesystem based on the update of the first metadata.

15. The computer system of claim 11, wherein the program instructions further cause the processor set to:
detect one or more issues associated with the update of the first base layer with the second base layer;
generate an error report based on the detection of the one or more issues; and
output the error report on a user device.

16. The computer system of claim 15, wherein the error report comprises a summary of the update of the first base layer with the second base layer, the one or more issues, a set of error codes associated with the one or more issues, and one or more actionable insights to resolve the one or more issues.

17. The computer system of claim 15, wherein the program instructions further cause the processor set to:
obtain container information of the at least one operational container; and
update a state of the at least one operational container based on the container information and the one or more issues.

18. The computer system of claim 17, wherein the container information of the at least one operational container comprises at least one of a process identifier of the at least one operational container, a name of the at least one operational container, a user identifier associated with a user of the at least one operational container, a file associated with the at least one operational container, network connection information of the at least one operational container, a memory usage information of the at least one operational container, thread information associated with the at least one operational container, a network namespace associated with the at least one operational container, a process tree associated with the at least one operational container, a file descriptor of the at least one operational container, a control group of the at least one operational container, a run time information of the at least one operational container, or security context information of the at least one operational container.

19. The computer system of claim 11, wherein the replacement memory corresponds to a logical memory within the at least one containerization system.

20. A computer program product for updating a first base layer of at least one operational container, the computer program product comprising:
one or more computer-readable storage media; and
program instructions stored on the one or more computer-readable storage media to perform operations comprising:
detecting a trigger to update the first base layer of the at least one operational container;
importing the at least one operational container in a replacement memory of at least one containerization system based on the detection of the trigger;
importing a second base layer of the at least one operational container in the replacement memory based on the importation of the at least one operational container in the replacement memory;
associating the second base layer with a container filesystem of the at least one operational container based on the importation of the second base layer in the replacement memory; and
updating the first base layer with the second base layer based on the association of the second base layer.
